(19) United States
(12) Patent Application Publication
(10) Pub. No.: US 2015/0088798 A1
(43) Pub. Date: Mar. 26, 2015

(54) DETECTING BEHAVIORAL PATTERNS AND ANOMALIES USING METADATA

(71) Applicant: MASTERCARD INTERNATIONAL INCORPORATED, Purchase, NY (US)

(72) Inventors: Misha Ghosh, Charlotte, NC (US); Randy Shuken, Westport, CT (US)

(73) Assignee: MASTERCARD INTERNATIONAL INCORPORATED, Purchase, NY (US)

(21) Appl. No.: 14/033,867

(22) Filed: Sep. 23, 2013

(51) Int. Cl. G06N 5/02

(52) U.S. Cl. CPC G06N 5/02
USPC 706/46

(57) ABSTRACT

A method and a system are provided that include retrieving, from one or more databases, a first set of information including metadata of electronic communications of one or more entities, and retrieving, from one or more databases, a second set of information including metadata of telecom communications of the one or more entities. The method and system also include analyzing the metadata of the electronic communications and the metadata of the telecom communications to determine one or more interconnection associations of the one or more entities, and identifying activities and characteristics attributable to the one or more entities based on the one or more interconnection associations. The method and system are useful for identifying networks through metadata to prevent criminal or other unlawful activity (e.g., fraud, theft, etc.) and/or to mine for opportunities.

### BACKGROUND OF THE DISCLOSURE

1. Field of the Disclosure

The present disclosure relates to a method and a system for detecting behavioral patterns and anomalies. More particularly, the present disclosure relates to a method and a system for detecting behavioral patterns and anomalies through the generation of interconnection associations that are based upon metadata of electronic communications and metadata of telecom communications of entities. Further, the present method and system can predict behavior and intent of entities based on the interconnection associations.

2. Description of the Related Art

Electronic storage mechanisms have enabled accumulation of massive amounts of data. For instance, data that previously required volumes of books for recordation can now be stored electronically without expense of printing paper and with a fraction of space needed for storage of paper. In one particular example, deeds and mortgages that were previously recorded in paper volumes can now be stored electronically. Moreover, advances in sensors technology now enables massive amounts of data to be collected in real-time. For instance, satellite based navigation systems, such as GPS, can determine the location of an individual or entity using satellites and receivers. The emergence of the interne and mobile computing devices has created new opportunities for data gathering in real-time. Computers and electronic storage devices can retain and store vast amounts of data from sensors and other data collection devices. Collected data relating to particular contexts and/or applications can be employed in connection with data trending and analysis, and predictions can be made as a function of received and analyzed data.

Predictive models utilized on computer systems can often produce more accurate predictive results than a human, as computer systems may have access to a substantial amount of data. For instance, a computer application can have access to data that represents traffic patterns over twenty years, whereas an individual may have experienced traffic patterns for a shorter period of time. These predictive models can be quite effective when generating predictions associated with common occurrences. Predictive models, however, can overwhelm an individual with predictions that may include superfluous information. Furthermore, predictive models can fail when used to predict events that are atypical, such as criminal activities or financial market activities. Reasons for failure can include lack of a necessary understanding of a situation, lack of critical data, infrequency of occurrence of an event, and other factors.

Simple causal-sequenced events (chain events) can be adequately modeled using existing physical models. However, activities by criminal and or other unlawful organizations not only attempt to hide their activities, but will act on opportunity rather than adhering to a predefined process. The impact of their opportunity based methods changes the sequence that renders the physical models ineffective for predicting future activity and events. Another example is where an adversary changes their methods, tactics, and procedures that renders the physical models ineffective for predicting future activity and events.

What is needed is a system and a method that adequately identify obfuscated relationships or interconnection associations that are hidden within large complex datasets to understand current activities and to predict future activities.

### SUMMARY OF THE DISCLOSURE

The present disclosure provides a method and a system for detecting behavioral patterns and anomalies, specifically for detecting behavioral patterns and anomalies through the generation of interconnection associations that are based upon metadata of electronic communications and metadata of telecom communications of entities.

The present disclosure also provides such a method and a system that predict behavior and intent of entities based upon the interconnection associations.

The present disclosure further provides a method that involves retrieving, from one or more databases, a first set of information including metadata of electronic communications of one or more entities, and retrieving, from one or more databases, a second set of information including metadata of telecom communications of the one or more entities. The method also involves analyzing the metadata of the electronic communications and the metadata of the telecom communications to determine one or more interconnection associations of the one or more entities, and identifying activities and characteristics attributable to the one or more entities based on the one or more interconnection associations.

The present disclosure still further provides a method that involves generating one or more network graphs based on the identified activities and characteristics of the one or more entities.

The present disclosure also provides a system that includes one or more databases configured to store a first set of information including metadata of electronic communications of one or more entities, one or more databases configured to store a first set of information including metadata of telecom communications of the one or more entities, and a processor. The processor is configured to analyze the metadata of the electronic communications and the metadata of the telecom communications to determine one or more interconnection associations of the one or more entities, and to identify activities and characteristics attributable to the one or more entities based on the one or more interconnection associations.

The present disclosure further provides a method for generating one or more interconnection associations. The method involves retrieving, from one or more databases, a first set of information including metadata of electronic communications of one or more entities, and retrieving, from one or more databases, a second set of information including metadata of telecom communications of the one or more entities. The method also involves analyzing the metadata of the electronic communications and the metadata of the telecom communications to determine one or more interconnection associations of the one or more entities.

The present disclosure yet further provides a system for generating one or more interconnection associations. The system includes one or more databases configured to store a first set of information including metadata of electronic communications of one or more entities, one or more databases configured to store a first set of information including metadata of telecom communications of the one or more entities, and a processor. The processor is configured to analyze the metadata of the electronic communications and the metadata of the telecom communications to determine one or more interconnection associations of the one or more entities.

In accordance with the present disclosure, electronic communications metadata and telecom communications metadata are leveraged to identify networks and information that is indicative of an entity's activities and characteristics, and to predict behavior and intent based on those activities and characteristics. Such activities and characteristics can include, but are not limited to, any one of economic espionage, industrial espionage, financial fraud, theft, and any other criminal or unlawful activity. The networks are helpful, especially during transition periods, e.g., when an employee turnover has taken place. Also, in the instance of employee theft, the method of this disclosure makes it easier to understand whether the employee in question acted alone or was part of a ring.

These and other systems, methods, objects, features, and advantages of the present disclosure will be apparent to those skilled in the art from the following detailed description of the embodiments and the drawings.

### BRIEF DESCRIPTION OF THE DRAWINGS

FIG. 1 is a flow chart illustrating a method in accordance with exemplary embodiments of this disclosure.

FIG. 2 is a block diagram illustrating a dataset in accordance with exemplary embodiments of this disclosure.

FIG. 3 is a chart illustrating various metadata of electronic communications in accordance with exemplary embodiments of this disclosure.

FIG. 4 is a chart illustrating various metadata of telecom communications in accordance with exemplary embodiments of this disclosure.

FIG. 5 a block diagram illustrating the creation of interconnection associations and activities and characteristics of entities in accordance with exemplary embodiments of this disclosure.

FIG. 6 is a diagram illustrating a network graph on a graphical user interface (GUI) according to an illustrative embodiment of this disclosure.

FIG. 7 is a diagram illustrating connectors that can be used in the graphical user interfaces (GUIs) according to example embodiments of this disclosure.

A component or a feature that is common to more than one figure is indicated with the same reference number in each figure.

### DESCRIPTION OF THE EMBODIMENTS

Embodiments of the present disclosure can be described more fully hereinafter with reference to the accompanying drawings, in which some, but not all, embodiments of the present disclosure are shown. Indeed, the present disclosure may be embodied in many different forms and should not be construed as limited to the embodiments set forth herein. Rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when stated that something is “based on” something else, it can be based on one or more other things as well. In other words, unless expressly indicated otherwise, as used herein “based on” means “based at least in part on” or “based at least partially on.”

As used herein, “entity” or “entities” includes one or more persons, organizations, businesses, institutions and/or other entities such as financial institutions, services providers, and the like that implement one or more portions of one or more of the embodiments described and/or contemplated herein. In particular, entities include a person, business, school, club, fraternity or sorority, an organization having members in a particular trade or profession, sales representative for particular products, charity, not-for-profit organization, labor union, local government, government agency, or political party.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, so that the processor can read information from, and write information to, the storage medium. In the alternative, the storage medium can be integral to the processor. Further, in some embodiments, the processor and the storage medium reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Computer program code for carrying out operations of embodiments of the present disclosure may be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It should be understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner so that the instructions stored in the computer readable memory produce an article of manufacture including instruction means that implement the function/act specified in the flowchart and/or block diagram block(s).

The computer program instructions can be loaded onto a computer or other programmable data processing apparatus to cause a series of operational steps to be performed on the computer or other programmable apparatus to produce a computer-implemented process so that the instructions that execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of this disclosure.

Thus, apparatus, systems, methods and computer program products are herein disclosed to identify, analyze, extract and correlate metadata of electronic communications and metadata of telecom communications of entities to generate interconnection associations for detecting behavioral patterns and anomalies of entities. Embodiments of the present disclosure will leverage the metadata available to identify information that is indicative of an entity's activities and characteristics and to predict behavior and intent based on those activities and characteristics. Such activities and characteristics can include, but are not limited to, any one of economic espionage, industrial espionage, financial fraud, theft, and any other criminal or unlawful activity.

For example, if an employee commits fraud, from the metadata analyzed in accordance with this disclosure, it is easy to see if the employee acted alone or as part of a ring. Also, when employees and contractors leave a company, the metadata can help prevent intellectual property from leaving the company with the employees and contractors. Further, when a sales employee leaves the company, the metadata can help prevent the sales contacts from getting lost.

The method and system are useful for identifying networks through metadata to prevent criminal or other unlawful activity (e.g., fraud, theft, and the like) and to mine for opportunities. For example, in large corporations, many e-mails, instant messages, phone calls and voice messages are sent back and forth internally and externally on a daily basis. Rather than scanning the contents of the e-mails and phone conversations, the present disclosure harvests the metadata of electronic communications and telecom communications and connects them together to identify interconnectedness.

Further, from the metadata analyzed in accordance with this disclosure, it can be determined who is the initiating entity and who is the receiving entity of an electronic communication or a telecom communication. For example, in a ring or an interconnected relationship, the metadata analyzed in accordance with this disclosure can identify who is initiating a conversation and who is the receiving beneficiary of the conversation. Knowing the initiator and the resulting follower/following relationship can allow for the determination of the ring leader probabilistically.

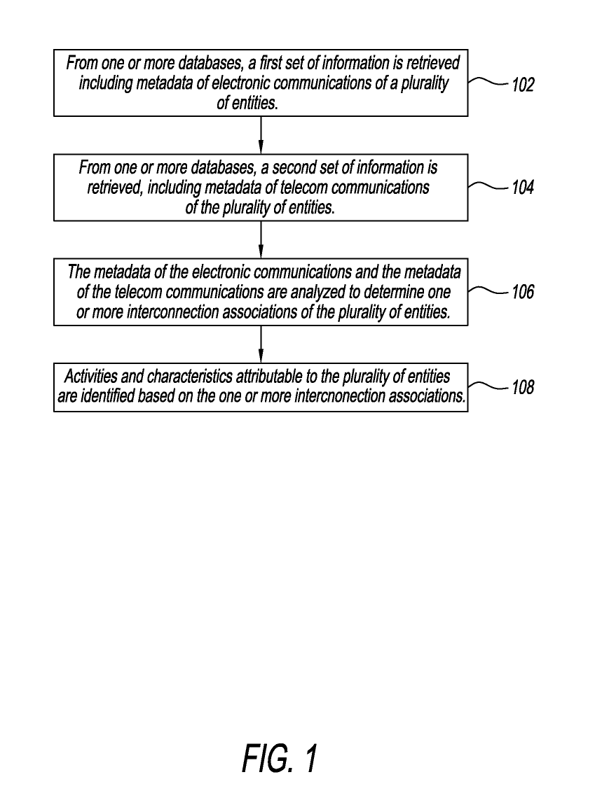

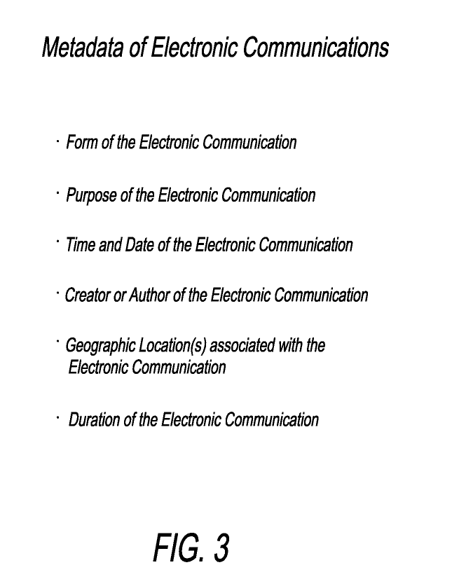

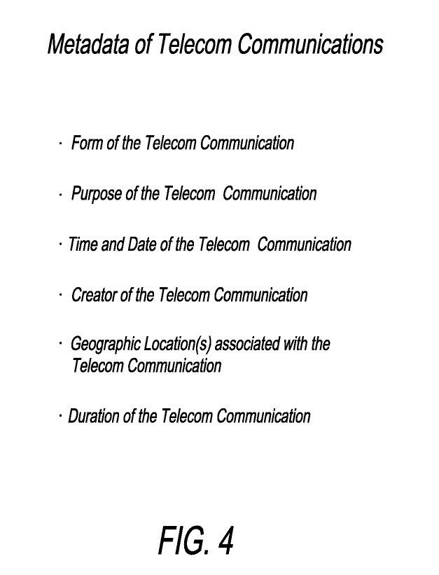

Referring to the drawings and, in particular, FIG. 1, the method of this disclosure includes analyzing electronic communication metadata and telecom communication metadata of entities, determining interconnection associations of the entities, and identifying activities and characteristics of the entities. The method involves at 102 retrieving, from one or more databases, a first set of information including metadata of electronic communications of one or more entities. The metadata information at 102 comprises at least one form of electronic communication, the purpose of the electronic communication, the time and date of the electronic communication, the creator or author of the electronic communication, the geographic location(s) associated with the electronic communication, the duration of the electronic communication, and the standards used (see FIG. 3). The method of this disclosure also involves retrieving, from one or more databases, a second set of information including metadata of telecom communications of the one or more entities. The metadata information at 104 comprises at least one form of telecom communication, the purpose of the telecom communication, the time and date of the telecom communication, the creator of the telecom communication, the geographic location(s) associated with the telecom communication, the duration of the telecom communication, and the standards used (see FIG. 4).

The metadata of the electronic communications and the metadata of the telecom communications are analyzed at 106 to determine one or more interconnection associations of the one or more entities. Activities and characteristics attributable to the one or more entities are identified at 108 based on the one or more interconnection associations.

In accordance with the method of this disclosure, information that is stored in one or more databases can be retrieved (e.g., by a processor). The information can contain, for example, metadata of electronic communications and metadata of telecom communications of entities used to generate interconnection associations for detecting behavioral patterns and anomalies of entities. In an embodiment, all metadata information stored in one or more databases can be retrieved. In another embodiment, only a single entry of metadata in the one or more databases can be retrieved. The retrieval of metadata information can be performed a single time or multiple times. In an exemplary embodiment, only metadata information pertaining to a specific interconnection association can be retrieved from the one or more databases.

In accordance with the method of this disclosure, metadata of electronic communications and metadata of telecom communications are analyzed to determine one or more interconnection associations of one or more entities. Interconnection associations can be determined based on the metadata information that was obtained and stored in the one or more databases. The selection of metadata information for determining interconnection association(s) can be different in every instance. In one embodiment, all metadata information stored in the one or more databases can be used for determining interconnection associations. In an alternative embodiment, only a portion of the metadata information is used. The determination of interconnection associations can be based on specific criteria.

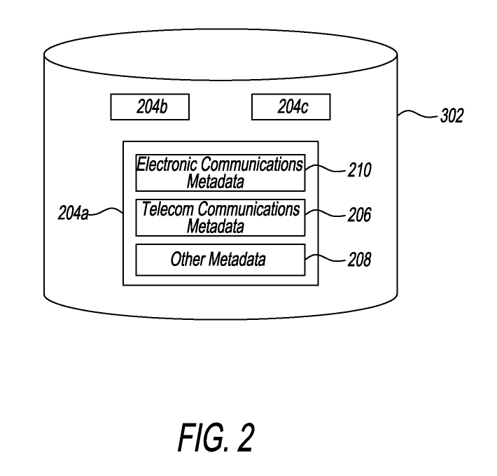

FIG. 2 illustrates an exemplary dataset 202 for the storing, reviewing, and/or analyzing of metadata information used in generating interconnection associations. The dataset 202 can contain a plurality of entries (e.g., entries 204a, 204b, and 204c).

The metadata of telecom communications 206 can include at least one form of telecom communication, the purpose of the telecom communication, the time and date of the telecom communication, the creator of the telecom communication, the geographic location(s) associated with the telecom communication, the duration of the telecom communication, and the standards used (see FIG. 4). The metadata of electronic communications 210 can include at least one form of electronic communication, the purpose of the electronic communication, the time and date of the electronic communication, the creator or author of the electronic communication, the geographic location(s) associated with the electronic communication, the duration of the electronic communication, and the standards used (see FIG. 3). Suitable types of metadata relevant for determining interconnection associations will be apparent to persons having skill in the relevant art. Other metadata information 208 can include any metadata information relevant to the particular application.

Interconnection associations are determined from the metadata of electronic communications and metadata of telecom communications obtained from the one or more databases. The metadata information is analyzed, extracted and correlated by an entity. Referring to FIG. 3, the metadata of electronic communications can include, for example, the form of the electronic communication, the purpose of the electronic communication, the time and date of the electronic communication, the creator or author of the electronic communication, the geographic location(s) associated with the electronic communication, the duration of the electronic communication, the standards used, and the like. Referring to FIG. 4, the metadata of telecom communications can include, for example, the form of the telecom communication, the purpose of the telecom communication, the time and date of the telecom communication, the creator of the telecom communication, the geographic location(s) associated with the telecom communication, the duration of the telecom communication, the standards used, and the like.

In an embodiment, metadata can be captured from various electronic communications and telecom communications known in the art. For example, electronic communication metadata can be captured from e-mails (e.g., time of the e-mail, names on the “To”, “CC” and “BCC” fields) and instant messaging (e.g., date and time stamp). Telecom communication metadata can be captured from phone/faxes (e.g., who the person called, date and time stamp of the call, and length of the conversation) and conference calls (e.g., meeting attendees).

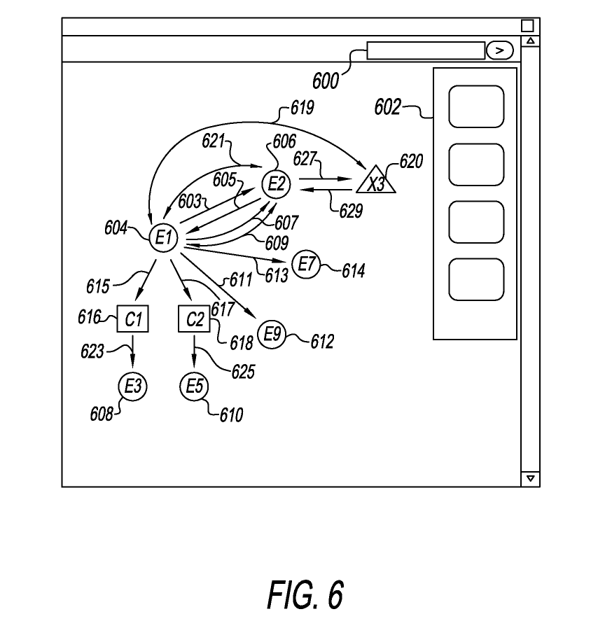

From the metadata, a network chain by “Person/Contact Name” can be created as shown in FIG. 6. This individual's roll-up entity can be determined by his or her e-mail address (e.g., Microsoft.com implies that someone within Microsoft is connected with this individual). In accordance with this disclosure, network graphs can be created from this roll-up entity.

In an embodiment, the metadata is weighed for importance. For example, phone communications and e-mails are of higher value than, for example, social media such as Facebook®, Pinterest®, Twitter®, Myspace®, LinkedIn®, MySpace®, and Google®. However, social media can be of value based on frequency and duration of the particular social media. The value of instant messaging and Skype®, for example, can be valued based on the duration of the particular activity. The weighting of metadata can be based on at least one of the form of metadata, frequency of metadata activities, amount of time between metadata activities, time and date of metadata activities, geographic location(s) of metadata activities, and duration of metadata activities.

In another embodiment, the metadata is filtered for relevance. For example, the metadata of electronic communications and metadata of telecom communications are filtered based on at least one of geographic location(s) of the identified activities, and time or duration of the identified activities. The filtering of metadata can be based on at least one of the form of metadata, frequency of metadata activities, amount of time between metadata activities, time and date of metadata activities, geographic location(s) of metadata activities, and duration of metadata activities.

As used herein, “interconnection association(s)” include activities criteria and selected characteristics criteria of a group of entities that can be valuable for detecting behavioral patterns and anomalies, criminal or unlawful behavior, theft, and the like. Interconnection associations can be given a minimum or a maximum size based on the number of entities. A minimum size of an interconnection association would be small enough to provide the granularity needed in a particular circumstance. In some instances, the size of an interconnection association can depend on the application. In one embodiment, an interconnection association includes at least ten entities.

Interconnection associations can be defined in part based on employment information, such as job title, job responsibilities, clearances for access to confidential information, and the like. Interconnection associations can also be defined in part based on geographical or demographical information, such as age, gender, income, marital status, postal code, income, spending propensity, familial status, and the like. In some embodiments, interconnection associations can be defined by a plurality of employment, geographical and/or demographical categories.

Interconnection associations can also be based on behavioral variables. An individual's behavior can be based on additional factors such as time, location, season, and the like. The factors and behaviors identified and used to define interconnection associations can vary widely and can be based on the application of the metadata information. Behavioral variables can also be applied to generated interconnection associations based on the attributes of the entities in the interconnection association.

In an embodiment, the electronic communications metadata and telecom communications metadata retrieved from the one or more databases can be analyzed to determine one or more interconnection associations of one or more entities. The one or more interconnection associations can be used to identify activities and characteristics attributable to the one or more entities. Behavioral information of one or more entities can be determined from the identified activities and characteristics. Also, information related to an intent of the one or more entities can be extracted from the behavioral information. The interconnection associations can be capable of predicting behavior and intent in the one or more entities.

Interconnection associations can be developed, for example, to identify activities and characteristics (e.g., identify criminal and unlawful behaviors) and create behavior associations. A behavior association can be a set of particular behaviors that predict another behavior.

There is the potential for numerous interconnection associations including, for example, those based in part upon the form of the electronic and telecom communications, the purpose of the electronic and telecom communications, the time and date of the electronic and telecom communications, the creator or author of the electronic and telecom communications, the geographic location(s) associated with the electronic and telecom communications, the duration of the electronic and telecom communications, and the standards used, and the like.

The creation of interconnection associations and other attributes can include, for example, business interconnection associations, industry interconnection associations, geographic interconnection associations, and demographic interconnection associations.

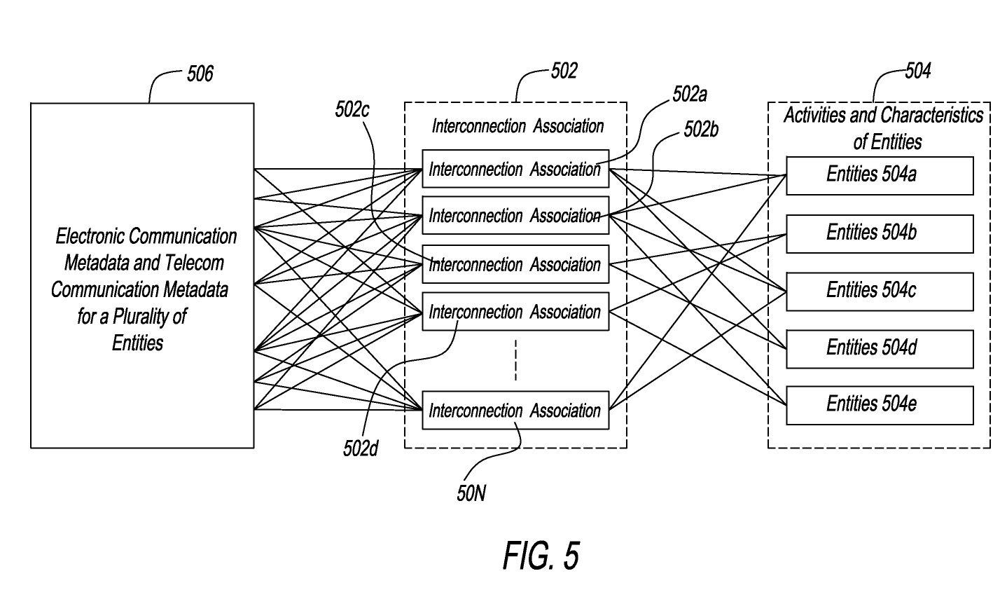

FIG. 5 illustrates the creation of activities and characteristics of entities 504 from interconnection associations 502. The creation of these activities and characteristics are based on electronic communication metadata and telecom communication metadata for one or more entities 506.

Entities can result from a combined group of interconnection associations that may be applied to an external set of data. For example, entities can result from a plurality of interconnection associations corresponding to electronic communication metadata and telecom communication metadata, as applied to an external data set by matching characteristics in respective interconnection associations to characteristics of entities to identify entities that have a propensity to carry out certain activities based on the selected activities criteria and/or selected characteristics criteria used in forming the interconnection associations.

In some embodiments, the entities can consist of a group of interconnection associations that do not share any common parameters. Entity parameters or attributes can be based on attributes received (e.g., from a third party employer or government agency). It will be apparent to persons having skill in the relevant art that the number of potential entities for a group of interconnection associations can be as large or larger than the group of interconnection associations itself. There can also be a combined grouping of entities, such as a group of entities identified by a third party (e.g., employer or government agency), which can be matched to a group of interconnection associations in order to identify potential activities characteristics of the entities based on activities and/or characteristics data of the corresponding interconnection associations.

As illustrated in FIG. 5, the plurality of interconnection associations 502 can be created based on the electronic communication metadata and telecom communication metadata for one or more entities 506. The electronic communication metadata and telecom communication metadata for the one or more entities 506 can consist of potentially billions of individual metadata (i.e., the metadata information that may be utilized in the creation of the plurality of interconnection associations 502). The metadata information can be obtained by an entity and stored in one or more databases (see FIG. 2).

The electronic communication metadata and telecom communication metadata used for the creation of interconnection associations can be selected based on attributes (e.g., received from a third party employer). The third party can select particular dates, times, geographic locations, and the like for the creation of interconnection associations. A plurality of interconnection associations 502 can be created, which can include interconnection association 502a, interconnection association 502b, and up to an interconnection association 502N, where N can represent the total number of the interconnection associations in the plurality of interconnection associations 502.

The activities and characteristics of entities 504 can be created based on the plurality of interconnection associations 502 as applied to a received external data set. The number of activities and characteristics of entities 504 can be at least as large as the number of interconnection associations in the plurality of interconnection associations 502. In an exemplary embodiment, the number of entities is less than the number of interconnection associations. In FIG. 5, the activities and characteristics of entities 504 is illustrated as including five entities groups, entities groups 504a-504e (e.g., based on five different sets of external data). Each entity group can comprise multiple interconnection associations. For example, entity group 504a can include interconnection associations 502a, 502b, and 502N. Each of the multiple interconnection associations in the entity group can have a common parameter. For instance, the interconnection associations 502a, 502b, and 502N that comprise entity group 504a can each be defined by the same form of the time and date of the electronic communication and telecom communication and the geographic location(s) associated with the electronic communication and telecom communication.

The entity groups can be based on predictions of future behavior. For instance, a company can analyze the metadata of electronic communications and metadata of telecom communications, interconnection associations and behavioral information to predict future behavior of entities. For example, the company can determine that entities in interconnection association 502a have a high theft propensity. An entity group (e.g., the entity group 504a) can consist of all interconnection associations (e.g., the interconnection associations 502a, 502b, and 502N) that contain entities with a high theft propensity.

Entity groups can also be aligned with other similar entity groups. Similar entity groups can be determined by similarities in, for example, the entity group parameters (e.g., criminal or unlawful behavior), or in the entities contained in the interconnection associations. In one embodiment, the company creates entity groups based on received parameters, which can be aligned to entity groups created by a third party on the same parameters yet include different entities or interconnection associations. The process and parameters for the alignment of entity groups can be dependent on the application of the entity groups, as will be apparent to persons having skill in the relevant art.

A plurality of interconnection associations can be generated. In some embodiments, each interconnection association include at least ten entities, which each entity having at least one attribute in common. In an exemplary embodiment, the generating of interconnection associations can include generating interconnection associations based on metadata having the following attributes: the form of the electronic or telecom communication, the purpose of the electronic or telecom communication, the time and date of the electronic or telecom communication, the creator or author of the electronic or telecom communication, the geographic location(s) associated with the electronic or telecom communication, and the duration of the electronic or telecom communication. Any interconnection association with less than a given number of entities (e.g., ten) can be deleted.

A company can analyze the generated interconnection associations (e.g., by analyzing the stored metadata and other data for each entity comprising the interconnection association) for behavioral information (e.g., unlawful behaviors and propensities). Networks generated from the interconnection associations and metadata are helpful during transition periods, e.g., when an employee turnover has taken place. Also, in the instance of employee theft, the method of this disclosure makes it easy to understand if the employee in question acted alone or was part of a ring. In some embodiments, the behavioral information can be represented by a behavioral score. Behavioral information can be assigned to each corresponding interconnection association or to an entity group.

Metadata, interconnection associations and behavioral information can be updated or refreshed at a specified time (e.g., on a regular basis or upon request of a party). Updating interconnection associations can include updating the entities included in each interconnection association with updated metadata of electronic communications and metadata of telecom communications. Metadata and interconnection associations can also be updated by changing the attributes that define each metadata and interconnection association, and generating a different set of metadata and interconnection associations. The process for updating behavioral information can depend on the circumstances regarding the need for the information itself.

Metadata and interconnection association data can also be combined or matched with other sources of data. For example, agencies, firms, employers, and the like can provide metadata or other information on entity groupings of their own. The company can link or match the received entity groupings, such as by matching groupings to generated interconnection associations based on selected metadata.

FIG. 6 is a diagram that illustrates a graphical user interfaces (GUI) according to exemplary embodiments of this disclosure. The electronic and telecom communications depicted in FIG. 6 can occur within a determined time period, e.g., a month period from April 1 to April 30, within an entity's firewall.

FIG. 6 illustrates a search control 600, an informational sidebar 602, a plurality of related entities 604 (employee E1), 606 (employee E2), 608 (employee E3), 610 (employee E5), 612 (employee E9), 614 (employee E7), 616 (contractor C1), 618 (contractor C2), and 620 (external contact X3), where each related entity (i.e., node) is connected by an edge 603, 605, 607, 609, 611. 613, 615, 617, 619, 621, 623 and 625. In general, a viewing user can provide a search string via the search control 600. A search result can be provided to the viewing user, where the viewing user can then select an entity to act as the focal entity (e.g., employee E1) in the network graph. Other methods of selecting a focal entity can be provided.

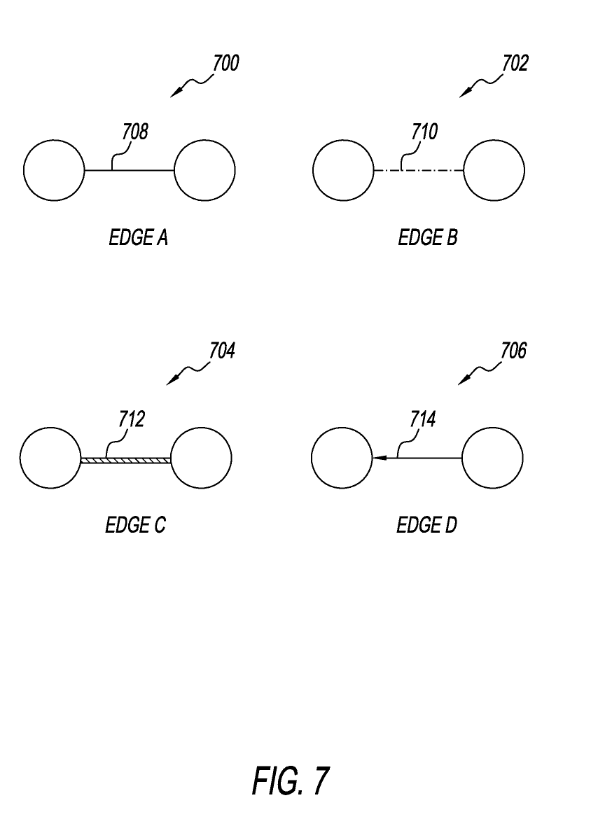

The focal entity 604 and other related entities, such as 606, 608, 610, 612, and 614 are connected using the identified edges 603, 605, 607, 609, 611, 613 and 621. The edges can be used to convey metadata information. For example, while an edge can be used to inherently show an interconnection association between two nodes, the edge can also be presented with characteristics that provide metadata information about the connection itself. Examples of such characteristics and their presentation are included in FIG. 7. Similarly, nodes can include metadata information.

Referring to FIG. 6, for example, edge 603 can represent 10 e-mails (e.g., 6 direct and 4 indirect (cc)) from 604 (employee E1) to 606 (employee E2). Edge 605 can represent 7 e-mails (e.g., 5 direct and 2 indirect (cc)) from 606 (employee E2) to 604 (employee E1). Edge 607 can represent 3 phone calls from 604 (employee E1) to 606 (employee E2). Edge 609 can represent 5 instant messages between 604 (employee E1) and 606 (employee E2). Also, edge 621 can represent 16 conference lines between 604 (employee E1) and 606 (employee E2).

Still referring to FIG. 6, a relationship between 606 (employee E2) and 620 (external contact X3) is evidenced by, for example, 2 telephone calls or numbers at edge 627 from 606 (employee E2) to 620 (external contact X3) and also 1 telephone call or number at edge 629 from 620 (external contact X3) to 606 (employee E2). A relationship also exists between 620 (external contact X3) and 604 (employee E1)—see edge 619 which can represent 2 phone calls or numbers from 620 (external contact X3) to 604 (employee E1).

FIG. 6 also shows other relationships or interconnection associations based on various metadata between 604 (employee E1) and 616 (contractor C1) at edge 615, between 616 (contractor C1) and 608 (employee E3) at edge 623, between 604 (employee E1) and 618 (contractor C2) at edge 617, between 618 (contractor C2) and 610 (employee E5) at edge 625, between 604 (employee E1) and 612 (employee E9) at edge 611, and between 604 (employee E1) and 614 (employee E7) at edge 613.

FIGS. 6 and 7 show nodes that can be included in a network graph, according to exemplary embodiments. In general, the nodes can be classified using their shape, border, interior area, and other auxiliary graphics. For example, a node can be presented with a shape that corresponds with a characteristic of the entity the node represents. The shape can be selected from the group of shapes including a circle, a square, a triangle, an octagon, an oval, or a star, in various embodiments. The particular shape used for a particular entity can be based on a type of entity, a demographic metric of the entity (e.g., age, gender, height, weight, marital status, and the like) or other characteristics of the entity represented by the node. In addition, a node's shape can be based on combinations of such characteristics. In the examples shown in FIGS. 6 and 7, the nodes have circular, square and triangular shapes.

FIGS. 6 and 7 illustrate examples of connectors (edges) that can be included in a network graph, according to exemplary embodiments. Although the edges are illustrated using circular, square and triangular nodes, it is understood that any representation of nodes can be used. Referring to FIG. 7, Edge A 700 is represented with a solid line 708. The solid line 708 can be presented with different widths or weights to indicate a characteristic of the relationship or interconnection association between the nodes. For example, a stronger relationship or interconnection association between the nodes can be represented with a wider or heavier line.

In FIG. 7, Edge B 702 is represented with a dashed line 710. The dashed line 710 can use varying patterns or widths (weight) to indicate a characteristic of the relationship or interconnection association between the nodes. For example, the dashed line 710 can be used to indicate a currency or recurrence of the metadata represented by the two nodes (e.g., less recent metadata can be represented using a grayscale dashed line and a more recent metadata can be represented with a solid bold line). As metadata ages, the dashed line used to represent the relationship or interconnection association can change (e.g., to be spaced farther apart or include more dots), until the metadata is so old that the relationship or interconnection association is no longer represented with an edge and the associated node on the distal end of the relationship or interconnection association cannot be displayed. Dashed lines or other connector characteristics can also be used to indicate other characteristics.

In FIG. 7, Edge C 704 is represented using a line 712 with a fill pattern. The fill pattern can vary based on characteristics of the relationship or interconnection association between the nodes. For example, the fill pattern can be used similar to that of the dashed line to indicate a currency of metadata. As metadata ages, the fill pattern can change, until the fill is completely transparent, indicating that the metadata is over some threshold age. As another example, the fill pattern can be used to indicate the type of metadata.

In FIG. 7, Edge D 706 is represented with a directed line 714. The directed line can include one or two arrowheads, indicating a unidirectional or bidirectional relationship or interconnection association, respectively. In addition, the arrowheads can be different to indicate a particular characteristic of the directional relationship or interconnection association.

Two or more of the edge representations can be combined to include multiple indicia of characteristics of the relationship or interconnection association between the nodes. For example, a heavy dashed line can be used to indicate a strong relationship or interconnection association between two nodes, where the dashed line is meant to indicate that the metadata has not been refreshed for over thirty days.

Other methods and graphical elements can be used to present metadata information related to a node or an edge to a viewer. For example, an informational window can be programmed to appear when a node or edge is active (e.g., when a cursor is positioned over or around the node or edge in the screen). The informational window can be a tooltip window, a popup window, a child window, or other graphical user interface construct to provide graphical, textual, or other data to the viewer corresponding to information associated with the active node or edge. In another example, a user can activate a node or edge, such as by clicking on the node or edge of interest, which can then cause information to be displayed in the informational sidebar 602.

The user interface can include a legend to indicate to the viewing user what each graphical feature of an edge or node represents in the network graph.

The network graph can be delivered using electronic presentation (e.g., a webpage, an email, mobile web, compact disc read only memory (CD-ROM)), physical presentation (e.g., a magazine, newsletter, book, pamphlet, or flyer), or other graphical media. The network graph can be configured or programmed to allow the viewing user to interact with the network graph. For example, the viewing user can refocus, zoom in or out to see more detail of a particular section of the network graph or to see a wider view of the complete network graph, pan or scroll to move portions of the network graph into view, or use other user interface commands or controls to otherwise change the view, perspective, or content of the network graph.

Where methods described above indicate certain events occurring in certain orders, the ordering of certain events can be modified. Moreover, while a process depicted as a flowchart, block diagram, or the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
retrieving, from one or more databases, a first set of information including metadata of electronic communications of one or more entities;
retrieving, from one or more databases, a second set of information including metadata of telecom communications of the one or more entities;
analyzing the metadata of the electronic communications and the metadata of the telecom communications to determine one or more interconnection associations of the one or more entities; and
identifying activities and characteristics attributable to the one or more entities based on the one or more interconnection associations.

2. The method of claim 1, wherein the identified activities and characteristics are any one selected from the group consisting of economic espionage, industrial espionage, financial fraud, theft, and any other criminal or unlawful activity.

3. The method of claim 1, wherein the electronic communications is a communication selected from the group consisting of a computing device communication, a cellular telephone communication, a pager communication, and a personal digital assistant communication.

4. The method of claim 3, wherein the electronic communications comprise an email or a text message.

5. The method of claim 1, wherein the telecom communications is a communication selected from the group consisting of a cellular telephone communication, a land line telephone communication, and a computing device communication.

6. The method of claim 5, wherein the telecom communications is a call selected from the group consisting of a cellular telephone call, a land line telephone call, and a Skype call.

7. The method of claim 1, wherein the metadata of electronic communications comprises, for each electronic communication, at least one of the form of the electronic communication, the purpose of the electronic communication, the time and date of the electronic communication, the creator or author of the electronic communication, the geographic location(s) associated with the electronic communication, the duration of the electronic communication, and the standards used.

8. The method of claim 1, wherein the metadata of telecom communications comprises, for each telecom communication, at least one of the form of the telecom communication, the purpose of the telecom communication, the time and date of the telecom communication, the creator of the telecom communication, the geographic location(s) associated with the telecom communication, the duration of the telecom communication, and the standards used.

9. The method of claim 1, wherein the electronic communications is generated by a device, and wherein said device is selected from the group consisting of a computing device, a cellular telephone, a pager, and a personal digital assistant.

10. The method of claim 1, wherein the telecom communications is generated by a device, and wherein said device is selected from the group consisting of a cellular telephone, a land line telephone, and a computing device.

11. The method of claim 1, further comprising:
weighting the metadata of electronic communications and metadata of telecom communications based on at least one form of metadata, frequency of metadata activities, amount of time between metadata activities, time and date of metadata activities, geographic location(s) of metadata activities, and duration of metadata activities.

12. The method of claim 1, further comprising:
filtering the metadata of electronic communications and metadata of telecom communications based on at least one of geographic location(s) of metadata activities and time or duration of metadata activities.

13. The method of claim 1, wherein the first set of information including metadata of electronic communications comprises metadata of social network communications and the one or more entities comprise social network users.

14. The method of claim 13, wherein the social network is selected from the group consisting of Facebook®, Pinterest®, Twitter®, Myspace®, LinkedIn®, MySpace®, and Google®.

15. The method of claim 1, further comprising:
analyzing the one or more identified activities and characteristics to determine behavioral information of the one or more entities; and
extracting information related to an intent of the one or more entities from the behavioral information.

16. The method of claim 1, wherein the retrieving of the first set of information and the retrieving of the second set of information are from the same one or more databases.

17. The method of claim 1, further comprising:
generating one or more network graphs based on the interconnection associations of the one or more entities.

18. A system comprising:
one or more databases configured to store a first set of information including metadata of electronic communications of one or more entities;
one or more databases configured to store a first set of information including metadata of telecom communications of the one or more entities; and
a processor configured to
analyze the metadata of the electronic communications and the metadata of the telecom communications to determine one or more interconnection associations of the one or more entities; and
identify activities and characteristics attributable to the one or more entities based on the one or more interconnection associations.

19. A method for generating one or more interconnection associations, said method comprising:
retrieving, from one or more databases, a first set of information including metadata of electronic communications of one or more entities;
retrieving, from one or more databases, a second set of information including metadata of telecom communications of the one or more entities; and
analyzing the metadata of the electronic communications and the metadata of the telecom communications to determine one or more interconnection associations of the one or more entities.

20. The method of claim 19, wherein the interconnection associations are capable of predicting behavior and intent of the one or more entities.

21. A system for generating one or more interconnection associations, said system comprising:
one or more databases configured to store a first set of information including metadata of electronic communications of one or more entities;
one or more databases configured to store a first set of information including metadata of telecom communications of the one or more entities; and
a processor configured to analyze the metadata of the electronic communications and the metadata of the telecom communications to determine one or more interconnection associations of the one or more entities.
